(19) United States
(12) Patent Application Publication
(10) Pub. No.: US 2024/0004514 A1
(43) Pub. Date: Jan. 4, 2024

(54) SYSTEMS AND METHODS FOR MODIFYING AN OBJECT MODEL

(71) Applicant: Honeywell International Inc., Charlotte, NC (US)

(72) Inventors: Divya SARIN, Bangalore (IN); Klaus GROSS, Atlanta, GA (US); Aaron D'SOUZA, Bangalore (IN); Agniraj CHATTERJI, Atlanta, GA (US); Roshan VALDER, Bangalore (IN); Anupam GARG, Bangalore (IN)

(21) Appl. No.: 17/931,915

(22) Filed: Sep. 14, 2022

(30) Foreign Application Priority Data
Jun. 29, 2022 (IN) 202211037323

(51) Int. Cl. G06F 3/04817; G06F 3/0482; G06F 3/0484

(52) U.S. Cl. CPC G06F 3/04817; G06F 3/0482; G06F 3/0484

(57) ABSTRACT

Disclosed are methods and systems for navigating a graphical user interface. A method may include, for example, retrieving an object model including (1) telemetry data associated with a plurality of mapped assets and (2) a first set of contextual data associated with the plurality of mapped assets; causing a visual representation of the object model to be displayed via the user device; detecting an unmapped asset; causing display of an unmapped asset icon associated with the unmapped asset in the visual representation; receiving an icon selection indicative of the unmapped asset icon; causing display of a context generation menu; receiving a second set of contextual data; and associating the second set of contextual data with the unmapped asset.

### CROSS-REFERENCE TO RELATED APPLICATION(S)

This patent application claims the benefit of priority to Indian Application No. 202211037323, filed Jun. 29, 2022, the entirety of which is incorporated herein by reference.

### TECHNICAL FIELD

Various embodiments of the present disclosure relate generally to systems and methods for modifying an object model and, more particularly, to systems and methods for modifying an object model via a graphical user interface.

### BACKGROUND

As more devices become digitized and connected to networks to expand the Internet of Things, enterprise performance management tools will become even more important for managing and monitoring these devices. Enterprise performance management tools may make huge amounts of information available to users tasked with managing and monitoring the devices. Adding new devices to enterprise performance management tools and ensuring that existing devices are appropriately represented by enterprise performance management tools, however, may be difficult and/or time consuming. Existing enterprise performance management tools may lack features allowing users to modify object models to accurately represent connected devices.

The present disclosure is directed to overcoming one or more of these above-referenced challenges.

### SUMMARY OF THE DISCLOSURE

According to certain aspects of the disclosure, systems and methods for modifying an object model are described.

In one example, a method may include: retrieving, by a system comprising at least one processor, an object model including (1) telemetry data associated with a plurality of mapped assets and (2) a first set of contextual data associated with the plurality of mapped assets; receiving, by the system from a user device, a visualization request; and causing, by the system in response to the visualization request, a visual representation of the object model to be displayed via the user device. The visual representation may include (1) a plurality of asset icons, wherein each of the plurality of asset icons is associated with at least one of the plurality of mapped assets, and (2) a first set of contextual identifiers indicative of the first set of contextual data. The method may further include: detecting, by the system, an unmapped asset; causing, by the system, display of an unmapped asset icon associated with the unmapped asset in the visual representation; receiving, by the system from the user device, an icon selection indicative of the unmapped asset icon; causing, by the system in response to the icon selection, display of a context generation menu, receiving, by the system from the user device via the context generation menu, a second set of contextual data; and associating, by the system in response to receiving the second set of contextual data, the second set of contextual data with the unmapped asset.

In some embodiments, the method may include causing, by the system in response to associating the second set of contextual data with the unmapped asset, a second set of contextual identifiers indicative of the second set of contextual data to be displayed in the visual representation.

In some embodiments, the second set of contextual data may be indicative of a facility in which the unmapped asset is located.

In some embodiments, the second set of contextual data may be indicative of an area of the facility in which the unmapped asset is located.

In some embodiments, the visual representation may further include a plurality of telemetry icons, wherein each of the plurality of telemetry icons may be associated with telemetry data for at least one of the plurality of mapped assets.

In some embodiments, the method may further include receiving, by the system from the user device, a bulk icon selection indicative of a first subset of the plurality of asset icons; receiving, by the system from the user device, a third set of contextual data; and associating, by the system in response to receiving the third set of contextual data, the third set of contextual data with each of the first subset of the plurality of asset icons.

In some embodiments, the first set of contextual identifiers may include a plurality of location icons, wherein each of the plurality of asset icons may be associated with at least one of the plurality of location icons.

In some embodiments, each of the plurality of location icons may be configured to be togglable such that associated asset icons may be selectively hidden.

In some embodiments, the method may further include receiving, by the system from the user device, a location icon selection indicative of one of the plurality of location icons; and removing, by the system in response to receiving the location icon selection, location icons not indicated by the location icon selection from the visual representation.

In another example, a method may include: retrieving, by a system comprising at least one processor, an object model including (1) telemetry data associated with a plurality of mapped assets and (2) a first set of contextual data associated with the plurality of mapped assets; receiving, by the system from a user device, a visualization request; and causing, by the system in response to the visualization request, a visual representation of the object model to be displayed via the user device, the visual representation including (1) a plurality of telemetry icons, wherein each of the plurality of telemetry icons may be associated with telemetry data for at least one of the plurality of mapped assets, (2) a plurality of asset icons associated with at least one of the plurality of mapped assets, and (3) a first set of contextual identifiers indicative of the first set of contextual data and linking each of the plurality of telemetry icons to at least one of the plurality of asset icons; detecting, by the system, a first set of unmapped telemetry data; causing, by the system, display of an unmapped telemetry icon associated with the first set of unmapped telemetry data in the visual representation; receiving, by the system from the user device, an icon selection indicative of the unmapped telemetry icon; causing, by the system in response to the icon selection, display of a context generation menu, receiving, by the system from the user device via the context generation menu, a second set of contextual data; and associating, by the system in response to receiving the second set of contextual data, the unmapped telemetry data with at least one of the plurality of mapped assets based on the second set of contextual data.

In some embodiments, the method may further include causing, by the system in response to associating the second set of contextual data with the unmapped telemetry data, to be displayed in the visual representation a second set of contextual identifiers indicative of associations between the unmapped telemetry data and the at least one of the plurality of mapped assets.

In some embodiments, the method may further include detecting, by the system, a plurality of sets of unmapped telemetry data; causing, by the system, display of a plurality of unmapped telemetry icons, wherein each of the plurality of unmapped telemetry icons is associated with at least one of the plurality of sets of unmapped telemetry data in the visual representation, wherein the icon selection is indicative of the plurality of unmapped telemetry icons; and associating, by the system in response to receiving the second set of contextual data, each of the plurality of sets of unmapped telemetry data with at least one of the plurality of mapped assets based on the second set of contextual data.

In some embodiments, the first set of contextual data may be indicative of a facility in which at least one of the plurality of mapped assets is located.

In some embodiments, the first set of contextual identifiers may include a plurality of location icons, wherein each of the plurality of asset icons may be associated with at least one of the plurality of location icons.

In some embodiments, each of the plurality of location icons may be configured to be togglable such that associated asset icons and telemetry icons may be selectively hidden.

In some embodiments, the method may further include receiving, by the system from the user device, an asset icon selection indicative of one of the plurality of asset icons; and removing, by the system in response to receiving the asset icon selection, asset icons not indicated by the asset icon selection from the visual representation.

In a further example, a system may include one or more memories storing instructions; and one or more processors operatively connected to the one or more memories. The one or more processors may be configured to execute the instructions to: retrieve an object model including (1) telemetry data associated with a plurality of mapped assets and (2) a first set of contextual data associated with the plurality of mapped assets; receive, from a user device, a visualization request; cause, in response to the visualization request, a visual representation of the object model to be displayed via the user device, the visual representation including (1) a plurality of telemetry icons, wherein each of the plurality of telemetry icons is associated with telemetry data for at least one of the plurality of mapped assets, (2) a plurality of asset icons associated with at least one of the plurality of mapped assets, and (3) a first set of contextual identifiers indicative of the first set of contextual data and linking each of the plurality of telemetry icons to at least one of the plurality of asset icons; detect a plurality of sets of unmapped telemetry data; cause display of a plurality of unmapped telemetry icons, wherein each of the plurality of unmapped telemetry icons may be associated with one of the plurality of sets of unmapped telemetry data in the visual representation; receive, from the user device, a bulk icon selection indicative of the plurality of unmapped telemetry icons; cause, in response to the bulk icon selection, display of a context generation menu; receive, from the user device via the context generation menu, a second set of contextual data; and associate, in response to receiving the second set of contextual data, each of the plurality of sets of unmapped telemetry data with at least one of the plurality of mapped assets based on the second set of contextual data.

In some embodiments, the one or more processors may be further configured to cause, in response to associating each of the plurality of sets of unmapped telemetry data with at least one of the plurality of mapped assets, to be displayed in the visual representation a second set of contextual identifiers indicative of associations between each of the plurality of sets of unmapped telemetry data with at least one of the plurality of mapped assets.

In some embodiments, the one or more processors may be further configured to receive, from the user device, an asset icon selection indicative of one of the plurality of asset icons; and remove, in response to receiving the asset icon selection, asset icons not indicated by the asset icon selection from the visual representation.

In some embodiments, the one or more processors may be further configured to remove, in response to receiving the asset icon selection, unmapped telemetry icons not associated with the asset icon indicated by the asset icon selection from the visual representation.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary networked computing system environment, according to one or more embodiments.

FIG. 2 depicts a schematic block diagram of a framework of an IoT platform of the networked computing system environment of FIG. 1, according to one or more embodiments.

FIG. 3 depicts an exemplary tabular window of an object model in a graphical user interface, according to one or more embodiments.

FIG. 4 depicts an exemplary visual representation of an object model in a graphical user interface, according to one or more embodiments.

FIG. 5 depicts an exemplary tabular window of an object model in a graphical user interface, according to one or more embodiments.

FIG. 6 depicts an exemplary context generation menu, according to one or more embodiments.

FIG. 7 depicts an exemplary visual representation of an object model in a graphical user interface, according to one or more embodiments.

FIG. 8 depicts an exemplary visual representation of an object model in a graphical user interface, according to one or more embodiments.

FIG. 9 depicts a flowchart of an exemplary method for modifying an object model, according to one or more embodiments.

FIG. 10 depicts a flowchart of an exemplary method for modifying an object model, according to one or more embodiments.

FIG. 11 depicts an exemplary system that may execute techniques presented herein.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Various embodiments of the present disclosure relate generally to systems and methods for modifying an object model and, more particularly, to systems and methods for modifying an object model via a graphical user interface.

Enterprise performance management (EPM) tools may make large amounts of information available to a user. EPM applications may be useful for warehouses, industrial plants, buildings, and other settings in which it is necessary to manage and monitor multiple connected devices. Dashboards of the EPM applications may be primary tools with which maintenance engineers, operators, and managers navigate available information to make day-to-day decisions, changes, and improvements to their processes to meet a wide range of targets.

Such dashboards, however, may not automatically incorporate new devices added to a facility. Rather, complex programming may be required to appropriately incorporate new devices into dashboards. Consequently, dashboards may have to be updated by a system administrator, or the like, to incorporate new devices and the incorporation may therefore significantly lag behind the addition and operation of new devices to a facility. As a result, maintenance engineers, operators, and managers may frequently be faced with dashboards that do not accurately represent a present state of the facility and the devices therein.

Accordingly, a need exists for improved dashboards that may be easily and conveniently updatable by common users. Specifically, a need exists for methods and systems by which object models powering such dashboard may be modified directly via a graphical user interface accessible by a user.

While this disclosure describes the systems and methods with reference to an Internet-of-Things platform, it should be appreciated that the present systems and methods may be applicable to other platforms, such as financial software platforms, social media platforms, internet search platforms, and other data intensive platforms. Further, while certain details of an Internet-of-Things platform are described herein, additional descriptions of such a platform may be found in U.S. application Ser. Nos. 15/971,140, 16/128,236, 15/956,862, 16/245,149, 16/660,122, and 16/812,027 (published as US 2019/0123959, US 2020/0084113. US 2019/0324838. US 2020/0225623, US 2021/0117436, and US 2020/0285203), which are incorporated by reference herein in their entirety.

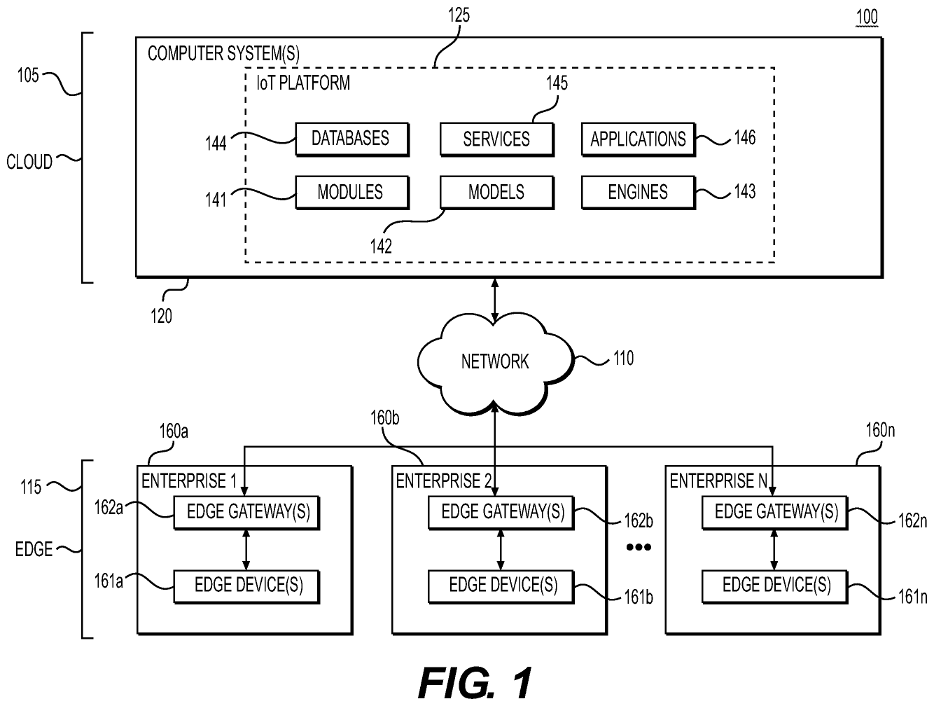

FIG. 1 illustrates an exemplary networked computing system environment 100, according to the present disclosure. As shown in FIG. 1, networked computing system environment 100 is organized into a plurality of layers including a cloud 105, a network 110, and an edge 115. As detailed further below, components of the edge 115 are in communication with components of the cloud 105 via network 110.

Network 110 may be any suitable network or combination of networks and may support any appropriate protocol suitable for communication of data to and from components of the cloud 105 and between various other components in the networked computing system environment 100 (e.g., components of the edge 115). Network 110 may include a public network (e.g., the Internet), a private network (e.g., a network within an organization), or a combination of public and/or private networks. Network 110 may be configured to provide communication between various components depicted in FIG. 1. Network 110 may comprise one or more networks that connect devices and/or components in the network layout to allow communication between the devices and/or components. For example, the network 110 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of the network layout. In some embodiments, network 110 may be implemented using cellular networks, satellite, licensed radio, or a combination of cellular, satellite, licensed radio, and/or unlicensed radio networks.

Components of the cloud 105 include one or more computer systems 120 that form a so-called “Internet-of-Things” or “IoT” platform 125. It should be appreciated that “IoT platform” is an optional term describing a platform connecting any type of Internet-connected device, and should not be construed as limiting on the types of computing systems useable within IoT platform 125. In particular, computer systems 120 may include any type or quantity of one or more processors and one or more data storage devices comprising memory for storing and executing applications or software modules of networked computing system environment 100. In one embodiment, the processors and data storage devices are embodied in server-class hardware, such as enterprise-level servers. For example, the processors and data storage devices may comprise any type or combination of application servers, communication servers, web servers, super-computing servers, database servers, file servers, mail servers, proxy servers, and/or virtual servers. Further, the one or more processors are configured to access the memory and execute processor-readable instructions, which when executed by the processors configures the processors to perform a plurality of functions of the networked computing system environment 100.

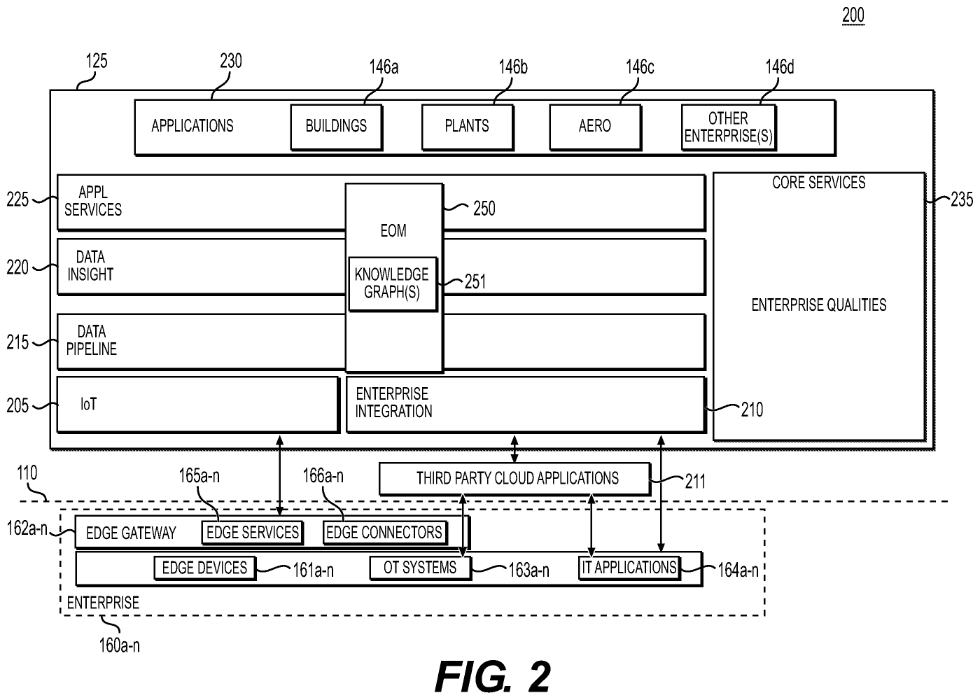

Computer systems 120 further include one or more software components of the IoT platform 125. For example, the software components of computer systems 120 may include one or more software modules to communicate with user devices and/or other computing devices through network 110. For example, the software components may include one or more modules 141, models 142, engines 143, databases 144, services 145, and/or applications 146, which may be stored in/by the computer systems 120 (e.g., stored on the memory), as detailed with respect to FIG. 2 below. The one or more processors may be configured to utilize the one or more modules 141, models 142, engines 143, databases 144, services 145, and/or applications 146 when performing various methods described in this disclosure.

Accordingly, computer systems 120 may execute a cloud computing platform (e.g., IoT platform 125) with scalable resources for computation and/or data storage, and may run one or more applications on the cloud computing platform to perform various computer-implemented methods described in this disclosure. In some embodiments, some of the modules 141, models 142, engines 143, databases 144, services 145, and/or applications 146 may be combined to form fewer modules, models, engines, databases, services, and/or applications. In some embodiments, some of the modules 141, models 142, engines 143, databases 144, services 145, and/or applications 146 may be separated into separate, more numerous modules, models, engines, databases, services, and/or applications. In some embodiments, some of the modules 141, models 142, engines 143, databases 144, services 145, and/or applications 146 may be removed while others may be added.

The computer systems 120 are configured to receive data from other components (e.g., components of the edge 115) of networked computing system environment 100 via network 110. Computer systems 120 are further configured to utilize the received data to produce a result. Information indicating the result may be transmitted to users via user computing devices over network 110. In some embodiments, the computer systems 120 may be referred to as a server system that provides one or more services including providing the information indicating the received data and/or the result(s) to the users. Computer systems 120 are part of an entity, which may include any type of company, organization, or institution that implements one or more IoT services. In some examples, the entity may be an IoT platform provider.

In an embodiment, cloud 105 may be operably coupled with a plurality of facilities or enterprises, meaning that communication between the cloud 105 and each of the facilities or enterprises is enabled. Operational data such as telemetry data and optionally associated metadata can be uploaded to the cloud 105 for processing. Telemetry data can include time stamps and data values corresponding to those time stamps. Instructions such as operational set points can be determined within the cloud 105 and can be downloaded to a particular facility or enterprise for execution. The operational set points may include, for example, air temperature, air humidity, delta pressure (e.g. for pump, fan or damper), pump speed, chilled water temperature, hot water temperature, etc.

In an embodiment, the cloud 105 may include a server that is programmed to communicate with the facilities or enterprises and to exchange data as appropriate. The cloud 105 may be a single computer server or may include a plurality of computer servers. In some embodiments, the cloud 105 may represent a hierarchal arrangement of two or more computer servers, where perhaps a lower level computer server (or servers) processes telemetry data, for example, while a higher-level computer server oversees operation of the lower level computer server or servers.

A facility or enterprise may include a variety of different devices and controllers that communicate in different data formats, in different languages and/or different protocols. A facility or enterprise may include a variety of different devices and controllers, at least some of which communicate on different types of networks.

Components of the edge 115 include one or more enterprises 160a-160n each including one or more edge devices 161a-161n and one or more edge gateways 162a-162n. For example, a first enterprise 160a includes first edge devices 161a and first edge gateways 162a, a second enterprise 160b includes second edge devices 161b and second edge gateways 162b, and an nth enterprise 160n includes nth edge devices 161n and nth edge gateways 162n. As used herein, enterprises 160a-160n may represent any type of entity, facility, or vehicle, such as, for example, companies, divisions, buildings, manufacturing plants, warehouses, real estate facilities, laboratories, aircraft, spacecraft, automobiles, ships, boats, military vehicles, oil and gas facilities, or any other type of entity, facility, and/or vehicle that includes any number of local devices.

The edge devices 161a-161n may represent any of a variety of different types of devices that may be found within the enterprises 160a-160n. Edge devices 161a-161n are any type of device configured to access network 110, or be accessed by other devices through network 110, such as via an edge gateway 162a-162n. Edge devices 161a-161n may be referred to in some cases as “IoT devices,” which may therefore include any type of network-connected (e.g., Internet-connected) device. For example, the edge devices 161a-161n may include sensors, actuators, processors, computers, valves, pumps, ducts, vehicle components, cameras, displays, doors, windows, security components, HVAC components, factory equipment, and/or any other devices that may be connected to the network 110 for collecting, sending, and/or receiving information. Each edge device 161a-161n includes, or is otherwise in communication with, one or more controllers for selectively controlling a respective edge device 161a-161n and/or for sending/receiving information between the edge devices 161a-161n and the cloud 105 via network 110. With reference to FIG. 2, the edge 115 may also include operational technology (OT) systems 163a-163n and information technology (IT) applications 164a-164n of each enterprise 161a-161n. The OT systems 163a-163n include hardware and software for detecting and/or causing a change, through the direct monitoring and/or control of industrial equipment (e.g., edge devices 161a-161n), assets, processes, and/or events. The IT applications 164a-164n include network, storage, and computing resources for the generation, management, storage, and delivery of data throughout and between organizations.

The edge gateways 162a-162n include devices for facilitating communication between the edge devices 161a-161n and the cloud 105 via network 110. For example, the edge gateways 162a-162n include one or more communication interfaces for communicating with the edge devices 161a-161n and for communicating with the cloud 105 via network 110. The communication interfaces of the edge gateways 162a-162n may include one or more cellular radios, Bluetooth, WiFi, near-field communication radios, Ethernet, or other appropriate communication devices for transmitting and receiving information. Multiple communication interfaces may be included in each gateway 162a-162n for providing multiple forms of communication between the edge devices 161a-161n, the gateways 162a-162n, and the cloud 105 via network 110. For example, communication may be achieved with the edge devices 161a-161n and/or the network 110 through wireless communication (e.g., WiFi, radio communication, etc.) and/or a wired data connection (e.g., a universal serial bus, an onboard diagnostic system, etc.) or other communication modes, such as a local area network (LAN), wide area network (WAN) such as the Internet, a telecommunications network, a data network, or any other type of network.

The edge gateways 162a-162n may also include a processor and memory for storing and executing program instructions to facilitate data processing. For example, the edge gateways 162a-162n can be configured to receive data from the edge devices 161a-161n and process the data prior to sending the data to the cloud 105. Accordingly, the edge gateways 162a-162n may include one or more software modules or components for providing data processing services and/or other services or methods of the present disclosure. With reference to FIG. 2, each edge gateway 162a-162n includes edge services 165a-165n and edge connectors 166a-166n. The edge services 165a-165n may include hardware and software components for processing the data from the edge devices 161a-161n. The edge connectors 166a-166n may include hardware and software components for facilitating communication between the edge gateway 162a-162n and the cloud 105 via network 110, as detailed above. In some cases, any of edge devices 161a-n, edge connectors 166a-n, and edge gateways 162a-n may have their functionality combined, omitted, or separated into any combination of devices. In other words, an edge device and its connector and gateway need not necessarily be discrete devices.

According to an example embodiment, the edge gateways 162a-162n may be configured to receive at least one of telemetry data and model data from various physical assets of a facility or enterprise (e.g., but not limited to, a building, an industrial site, a vehicle, a warehouse, an aircraft etc.). In some examples, the telemetry data can represent time-series data and may include a plurality of data values associated with the assets which can be collected over a period of time. For instance, in an example, the telemetry data may represent a plurality of sensor readings collected by a sensor over a period of time. Further, the model data can represent metadata associated with the assets. The model data can be indicative of ancillary or contextual information associated with the asset. For instance, in an example, the model data can be representative of a geographical information associated with the asset (e.g. location of the asset) within a facility. In another example, the model data can represent a sensor setting based on which a sensor is commissioned within a facility. In yet another example, the model data can be representative of a data type or a data format associated with the data transacted through the asset. In yet another example, the model data can be indicative of any information which can define a relationship of the asset with the other assets in a facility. In accordance with various example embodiments described herein, the term ‘model data’ can be referred interchangeably as ‘semantic model’ or ‘metadata’ for purpose of brevity.

In accordance with an example embodiment, the edge gateways 162a-162n are configured to discover and identify one or more local devices and/or any other physical assets which are communicatively coupled to the edge gateways 162a-162n. Further, upon identification of the assets, the edge gateways 162a-162n are configured to pull the telemetry data and/or the model data from the various assets. In an example, these assets can correspond to one or more electronic devices that may be located on-premises in a facility. The edge gateways 162a-162n are configured to pull the data by sending one or more data interrogation requests to the assets. These data interrogation requests can be based on a protocol supported by an underlying physical asset. Examples of discovery and identification of assets in a facility are described in a US Patent Application no. U.S. Ser. No. 16/888,626, titled “Remote discovery of building management system metadata”, filed on 29 May 2020, the details of which are incorporated herein in their entirety.

In accordance with said example embodiment, the edge gateways 162a-162n are configured to receive the telemetry data and/or the model data in various data formats or different data structures. In an example, a format of the telemetry data and/or the model data, received at the edge gateways 162a-162n may be in accordance with a communication protocol of the network supporting transaction of data amongst two or more network nodes (i.e. the edge gateways 162a-162n and the asset). As can be appreciated, in some examples, each asset in a facility can be support different network protocols (e.g., IOT protocols like BACnet, Modbus, LonWorks, SNMP, MQTT, Foxs, OPC UA etc.). Accordingly, the edge gateways 162a-162n are configured to pull the telemetry data and/or the model data, in accordance with communication protocol supported by an underlying local device (i.e. asset).

Further, the edge gateways 162a-162n are configured to process the received data and transform the data into unified data format. The unified data format is referred hereinafter as a common object model (COM). In an example, the COM is in accordance with an object model that may be required by one or more data analytics applications or services, supported at the cloud 105. In an example embodiment, the edge gateways 162a-162n can perform data normalization to normalize the received data into a pre-defined data format. In an example, the pre-defined format can represent a COM based on which the edge gateways 162a-162n can further push the telemetry data and/or the model data to the cloud 106. In some examples, the edge gateways 162a-162n are configured to establish a secure communication channel with the cloud 105. In this regard, the data can be transacted between the edge gateways 162a-162n and the cloud 105, via a secure communication channel.

In accordance with said example embodiment, the edge gateways 162a-162n are configured to perform at least one of: (a) receiving at least one of: telemetry data and the model data from the assets, (b) normalizing the data which can include transforming the received data from a first format into a second format that supports a COM, and (c) sending the transformed data representative of the COM to the cloud 105. In accordance with some example embodiments, the edge gateways 162a-162n are configured to receive and aggregate the data (e.g., but not limited to, telemetry data and/or model data) from multiple sources in a facility. For instance, the data and/or metadata information can be received and/or pulled from multiple assets corresponding to various independent and diverse sub-systems in the facility. Furthermore, as described earlier, the edge gateways 162a-162n are configured to normalize the received data and send the normalized data to the cloud 105. In an example, the edge gateways 162a-162n can send the transformed data based on a data pull request received from the cloud 105. In another example, the edge gateways 162a-162n can send the transformed data automatically at pre-defined time intervals.

In an example embodiment, the edge gateways 162a-162n are configured to define a protocol for performing at least one of: (a) data ingress from the one or more assets to the edge gateways 162a-162n, (b) data normalization (e.g. normalizing the data into a COM), and (c) data egress for pushing the data out from the edge gateways 162a-162n (for example, to the cloud 105) In this regard, the edge gateways 162a-162n can be configured to define one or more rules based on which the data (i.e. the telemetry data and/or the model data) can be ingress by the edge gateways 162a-162n for further processing. Further, the edge gateways 162a-162n can define rules for normalizing the data in accordance with a COM, as described earlier. Furthermore, the edge gateways 162a-162n can include a rule engine that can be configured to define rules for egressing the data and/or a transformed version of the data (e.g. the normalized data) out from the edge gateways 162a-162n. In some examples, the edge gateways 162a-162n can ingress the data and further push the data into a data lake (e.g. a data pipeline). In an example, the data lake can be managed by the edge gateways 162a-162n and/or the cloud 105.

In accordance with an example embodiment, the edge gateways 162a-162n are configured to support one or more containerized packages. These containerized packages include one or more applications, drivers, firmware executable files, services, or the like, that can be configured based on configuration information from the cloud 105. These containerized packages supported at the edge gateways 162a-162n can pull the telemetry data and/or the model data from the one or more assets in the facility. Further, in accordance with some example embodiments, the edge gateways 162a-162n are configured to utilize the containerized packages to perform one or more operations corresponding to at least one of: the data ingress, the data normalization, and the data egress, as described earlier. Furthermore, the containerized packages can be configured to control one or more operations associated with the assets of the facility.

In accordance with some example embodiments, the containerized packages can include one or more drivers that can be configured to auto-discover and identify one or more assets in a facility. In this regard, the containerized packages can enable the edge gateways 162a-162n to remotely access the assets, identify the one or more assets based on the interrogation of the assets, and configure one or more data transaction capabilities of the assets. The data transaction capability referred herein can for example indicate, what data is to be pulled from an asset or how frequent data is to be pulled from the asset, or what metadata is to be pulled from the asset. In accordance with said example embodiments, the containerized packages can be utilized to configure at least one of: (a) a selection of data which is to be pulled from an asset, (b) a frequency at which the data is to be pulled from an asset, (c) selection of an asset from amongst the multiple assets from which the data is to be requested by the edge gateways 162a-162n, (d) a selection of metadata associated with an asset which is to be requested by the edge gateways 162a-162n. In an example embodiment, a containerized package at the edge gateways 162a-162n can include one or more of: drivers, native firmware, library files, application file, and/or executable files that can enable one or more functions as described herein, with respect to the edge gateways 162a-162n.

According to some example embodiments, the containerized packages can be configured to pull the data from the assets onto the edge gateways 162a-162n by sending data interrogation requests to various assets. These data interrogation assets can be defined in a format in accordance with a network protocol supported by the assets. Typically, various assets of a facility may support different network protocols (e.g. IOT based protocols like BACnet, Modbus, Foxs, OPC UA, Obix, SNMP, MQTT etc.). In some example embodiments, the containerized packages are customizable and user-configurable so as to cater any type of asset supported by any network protocol. In other words, the containerized packages can be configured to pull the data and/or the metadata from various assets regardless of an underlying network protocol for communication with an asset. In accordance with some example embodiments, the edge gateways 162a-162n can support the one or more containerized packages that can cause automatic discovery and identification of assets of various subsystems in a facility regardless of an asset type (e.g. modern sub-system or legacy sub-system, OEM manufactured, native asset etc.).

As described earlier, the edge gateways 162a-162n are configured to capture the data (e.g. the telemetry data and the semantic model) from various assets in the facility. Further, the edge gateways 162a-162n are configured to provide at least one of: the data and a COM determined from the data, to the cloud 105. In some example embodiments, the cloud 105 can further process the data and/or the COM to create an extended object model (EOM). An extended object model is representative of a data model which unifies several data ontologies, data relationships, and data hierarchies into a unified format. The EOM can be utilized for further data analytics and reporting one or more KPIs, contextual insights, performance, and operational insights of a facility.

In some embodiments, the COM and/or the EOM may generate and/or suggest filter tags for the data. In other words, the COM and/or the EOM may ingest telemetry data and, using contextual information about the data (e.g. the semantic model), may assign filter tags to the data. The filter tags may accordingly be used to filter the potentially large amounts of data to desired granularity. In some embodiments, the COM and/or the EOM may assign geographic filter tags, filter tags identifying specific facilities, asset type filter tags, attribute filter tags, time series filter tags, or any other type of filter tags useful for sorting the data. For example, for a data element indicative of energy consumed by an individual boiler in a warehouse in Bangalore, the COM and/or the EOM may apply filter tags indicative of one or more of: the boiler, the system with which the boiler is associated, the warehouse, Bangalore, energy consumption, the sensor or meter used to detect the energy consumption, and the like. The COM and/or the EOM may assign filter tags to each data element ingested and/or maintained therein.

FIG. 2 illustrates a schematic block diagram of framework 200 of the IoT platform 125, according to the present disclosure. The IoT platform 125 of the present disclosure is a platform for enterprise performance management that uses real-time accurate models and visual analytics to deliver intelligent actionable recommendations for sustained peak performance of the enterprise 160a-160n. The IoT platform 125 is an extensible platform that is portable for deployment in any cloud or data center environment for providing an enterprise-wide, top to bottom view, displaying the status of processes, assets, people, and safety. Further, the IoT platform 125 supports end-to-end capability to execute digital twins against process data and to translate the output into actionable insights, using the framework 200, detailed further below.

As shown in FIG. 2, the framework 200 of the IoT platform 125 comprises a number of layers including, for example, an IoT layer 205, an enterprise integration layer 210, a data pipeline layer 215, a data insight layer 220, an application services layer 225, and an applications layer 230. The IoT platform 125 also includes a core services layer 235 and an extensible object model (EOM) 250 comprising one or more knowledge graphs 251. The layers 205-235 further include various software components that together form each layer 205-235. For example, each layer 205-235 may include one or more of the modules 141, models 142, engines 143, databases 144, services 145, applications 146, or combinations thereof. In some embodiments, the layers 205-235 may be combined to form fewer layers. In some embodiments, some of the layers 205-235 may be separated into separate, more numerous layers. In some embodiments, some of the layers 205-235 may be removed while others may be added.

The IoT platform 125 is a model-driven architecture. Thus, the extensible object model 250 communicates with each layer 205-230 to contextualize site data of the enterprise 160a-160n using an extensible object model (or “asset model”) and knowledge graphs 251 where the equipment (e.g., edge devices 161a-161n) and processes of the enterprise 160a-160n are modeled. The knowledge graphs 251 of EOM 250 are configured to store the models in a central location. The knowledge graphs 251 define a collection of nodes and links that describe real-world connections that enable smart systems. As used herein, a knowledge graph 251: (i) describes real-world entities (e.g., edge devices 161a-161n) and their interrelations organized in a graphical interface; (ii) defines possible classes and relations of entities in a schema; (iii) enables interrelating arbitrary entities with each other; and (iv) covers various topical domains. In other words, the knowledge graphs 251 define large networks of entities (e.g., edge devices 161a-161n), semantic types of the entities, properties of the entities, and relationships between the entities. Thus, the knowledge graphs 251 describe a network of “things” that are relevant to a specific domain or to an enterprise or organization. Knowledge graphs 251 are not limited to abstract concepts and relations, but can also contain instances of objects, such as, for example, documents and datasets. In some embodiments, the knowledge graphs 251 may include resource description framework (RDF) graphs. As used herein, a “RDF graph” is a graph data model that formally describes the semantics, or meaning, of information. The RDF graph can also represent metadata (e.g., data that describes data). Knowledge graphs 251 can also include a semantic object model. The semantic object model is a subset of a knowledge graph 251 that defines semantics for the knowledge graph 251. For example, the semantic object model defines the schema for the knowledge graph 251.

As used herein, EOM 250 is a collection of application programming interfaces (APIs) that enables seeded semantic object models to be extended. For example, the EOM 250 of the present disclosure enables a customer's knowledge graph 251 to be built subject to constraints expressed in the customer's semantic object model. Thus, the knowledge graphs 251 are generated by customers (e.g., enterprises or organizations) to create models of the edge devices 161a-161n of an enterprise 160a-160n, and the knowledge graphs 251 are input into the EOM 250 for visualizing the models (e.g., the nodes and links).

The models describe the assets (e.g., the nodes) of an enterprise (e.g., the edge devices 161a-161n) and describe the relationship of the assets with other components (e.g., the links). The models also describe the schema (e.g., describe what the data is), and therefore the models are self-validating. For example, the model can describe the type of sensors mounted on any given asset (e.g., edge device 161a-161n) and the type of data that is being sensed by each sensor. A key performance indicator (KPI) framework can be used to bind properties of the assets in the extensible object model 250 to inputs of the KPI framework. Accordingly, the IoT platform 125 is an extensible, model-driven end-to-end stack including: two-way model sync and secure data exchange between the edge 115 and the cloud 105, metadata driven data processing (e.g., rules, calculations, and aggregations), and model driven visualizations and applications. As used herein, “extensible” refers to the ability to extend a data model to include new properties/columns/fields, new classes/tables, and new relations. Thus, the IoT platform 125 is extensible with regards to edge devices 161a-161n and the applications 146 that handle those devices 161a-161n. For example, when new edge devices 161a-161n are added to an enterprise 160a-160n system, the new devices 161a-161n will automatically appear in the IoT platform 125 so that the corresponding applications 146 can understand and use the data from the new devices 161a-161n.

In some cases, asset templates are used to facilitate configuration of instances of edge devices 161a-161n in the model using common structures. An asset template defines the typical properties for the edge devices 161a-161n of a given enterprise 160a-160n for a certain type of device. For example, an asset template of a pump includes modeling the pump having inlet and outlet pressures, speed, flow, etc. The templates may also include hierarchical or derived types of edge devices 161a-161n to accommodate variations of a base type of device 161a-161n. For example, a reciprocating pump is a specialization of a base pump type and would include additional properties in the template. Instances of the edge device 161a-161n in the model are configured to match the actual, physical devices of the enterprise 160a-160n using the templates to define expected attributes of the device 161a-161n. Each attribute is configured either as a static value (e.g., capacity is 1000 BPH) or with a reference to a time series tag that provides the value. The knowledge graph 251 can automatically map the tag to the attribute based on naming conventions, parsing, and matching the tag and attribute descriptions and/or by comparing the behavior of the time series data with expected behavior.

The modeling phase includes an onboarding process for syncing the models between the edge 115 and the cloud 105. For example, the onboarding process can include a simple onboarding process, a complex onboarding process, and/or a standardized rollout process. The simple onboarding process includes the knowledge graph 251 receiving raw model data from the edge 115 and running context discovery algorithms to generate the model. The context discovery algorithms read the context of the edge naming conventions of the edge devices 161a-161n and determine what the naming conventions refer to. For example, the knowledge graph 251 can receive “TMP” during the modeling phase and determine that “TMP” relates to “temperature.” The generated models are then published. The complex onboarding process includes the knowledge graph 251 receiving the raw model data, receiving point history data, and receiving site survey data. The knowledge graph 251 can then use these inputs to run the context discovery algorithms. The generated models can be edited and then the models are published. The standardized rollout process includes manually defining standard models in the cloud 105 and pushing the models to the edge 115.

The IoT layer 205 includes one or more components for device management, data ingest, and/or command/control of the edge devices 161a-161n. The components of the IoT layer 205 enable data to be ingested into, or otherwise received at, the IoT platform 125 from a variety of sources. For example, data can be ingested from the edge devices 161a-161n through process historians or laboratory information management systems. The IoT layer 205 is in communication with the edge connectors 165a-165n installed on the edge gateways 162a-162n through network 110, and the edge connectors 165a-165n send the data securely to the IoT layer 205. In some embodiments, only authorized data is sent to the IoT platform 125, and the IoT platform 125 only accepts data from authorized edge gateways 162a-162n and/or edge devices 161a-161n. Data may be sent from the edge gateways 162a-162n to the IoT platform 125 via direct streaming and/or via batch delivery. Further, after any network or system outage, data transfer will resume once communication is re-established and any data missed during the outage will be backfilled from the source system or from a cache of the IoT platform 125. The IoT layer 205 may also include components for accessing time series, alarms and events, and transactional data via a variety of protocols.

The enterprise integration layer 210 includes one or more components for events/messaging, file upload, and/or REST/OData. The components of the enterprise integration layer 210 enable the IoT platform 125 to communicate with third party cloud applications 211, such as any application(s) operated by an enterprise in relation to its edge devices. For example, the enterprise integration layer 210 connects with enterprise databases, such as guest databases, customer databases, financial databases, patient databases, etc. The enterprise integration layer 210 provides a standard application programming interface (API) to third parties for accessing the IoT platform 125. The enterprise integration layer 210 also enables the IoT platform 125 to communicate with the OT systems 163a-163n and IT applications 164a-164n of the enterprise 160a-160n. Thus, the enterprise integration layer 210 enables the IoT platform 125 to receive data from the third party applications 211 rather than, or in combination with, receiving the data from the edge devices 161a-161n directly.

The data pipeline layer 215 includes one or more components for data cleansing/enriching, data transformation, data calculations/aggregations, and/or API for data streams. Accordingly, the data pipeline layer 215 can pre-process and/or perform initial analytics on the received data. The data pipeline layer 215 executes advanced data cleansing routines including, for example, data correction, mass balance reconciliation, data conditioning, component balancing and simulation to ensure the desired information is used as a basis for further processing. The data pipeline layer 215 also provides advanced and fast computation. For example, cleansed data is run through enterprise-specific digital twins. The enterprise-specific digital twins can include a reliability advisor containing process models to determine the current operation and the fault models to trigger any early detection and determine an appropriate resolution. The digital twins can also include an optimization advisor that integrates real-time economic data with real-time process data, selects the right feed for a process, and determines optimal process conditions and product yields.

The data pipeline layer 215 may also use models and templates to define calculations and analytics, and define how the calculations and analytics relate to the assets (e.g., the edge devices 161a-161n). For example, a pump template can define pump efficiency calculations such that every time a pump is configured, the standard efficiency calculation is automatically executed for the pump. The calculation model defines the various types of calculations, the type of engine that should run the calculations, the input and output parameters, the preprocessing requirement and prerequisites, the schedule, etc. The actual calculation or analytic logic may be defined in the template or it may be referenced. Thus, the calculation model can be used to describe and control the execution of a variety of different process models. Calculation templates can be linked with the asset templates such that when an asset (e.g., edge device 161a-161n) instance is created, any associated calculation instances are also created with their input and output parameters linked to the appropriate attributes of the asset (e.g., edge device 161a-161n).

The IoT platform 125 can support a variety of different analytics models including, for example, first principles models, empirical models, engineered models, user-defined models, machine learning models, built-in functions, and/or any other types of analytics models. Fault models and predictive maintenance models will now be described by way of example, but any type of models may be applicable.

Fault models are used to compare current and predicted enterprise 160a-160n performance to identify issues or opportunities, and the potential causes or drivers of the issues or opportunities. The IoT platform 125 includes rich hierarchical symptom-fault models to identify abnormal conditions and their potential consequences. For example, the IoT platform 125 can drill down from a high-level condition to understand the contributing factors, as well as determining the potential impact a lower level condition may have. There may be multiple fault models for a given enterprise 160a-160n looking at different aspects such as process, equipment, control, and/or operations. Each fault model can identify issues and opportunities in their domain, and can also look at the same core problem from a different perspective. An overall fault model can be layered on top to synthesize the different perspectives from each fault model into an overall assessment of the situation and point to the true root cause.

When a fault or opportunity is identified, the IoT platform 125 can make recommendations about the best corrective actions to take. Initially, the recommendations are based on expert knowledge that has been pre-programmed into the system by process and equipment experts. A recommendation services module presents this information in a consistent way regardless of source, and supports workflows to track, close out, and document the recommendation follow-up. The recommendation follow-up can be used to improve the overall knowledge of the system over time as existing recommendations are validated (or not) or new cause and effect relationships are learned by users and/or analytics.

The models can be used to accurately predict what will occur before it occurs and interpret the status of the installed base. Thus, the IoT platform 125 enables operators to quickly initiate maintenance measures when irregularities occur. The digital twin architecture of the IoT platform 125 can use a variety of modeling techniques. The modeling techniques can include, for example, rigorous models, fault detection and diagnostics (FDD), descriptive models, predictive maintenance, prescriptive maintenance, process optimization, and/or any other modeling technique.

The rigorous models can be converted from process design simulation. In this manner, process design is integrated with feed conditions and production requirement. Process changes and technology improvement provide business opportunities that enable more effective maintenance schedule and deployment of resources in the context of production needs. The fault detection and diagnostics include generalized rule sets that are specified based on industry experience and domain knowledge and can be easily incorporated and used working together with equipment models. The descriptive models identify a problem and then the predictive models can determine possible damage levels and maintenance options. The descriptive models can include models for defining the operating windows for the edge devices 161a-161n.

Predictive maintenance includes predictive analytics models developed based on rigorous models and statistic models, such as, for example, principal component analysis (PCA) and partial least square (PLS). Machine learning methods can be applied to train models for fault prediction. Predictive maintenance can leverage FDD-based algorithms to continuously monitor individual control and equipment performance. Predictive modeling is then applied to a selected condition indicator that deteriorates in time. Prescriptive maintenance includes determining what is the best maintenance option and when it should be performed based on actual conditions rather than time-based maintenance schedule. Prescriptive analysis can select the right solution based on the company's capital, operational, and/or other requirements. Process optimization is determining optimal conditions via adjusting set-points and schedules. The optimized set-points and schedules can be communicated directly to the underlying controllers, which enables automated closing of the loop from analytics to control.

The data insight layer 220 includes one or more components for time series databases (TSDB), relational/document databases, data lakes, blob, files, images, and videos, and/or an API for data query. When raw data is received at the IoT platform 125, the raw data can be stored as time series tags or events in warm storage (e.g., in a TSDB) to support interactive queries and to cold storage for archive purposes. Data can further be sent to the data lakes for offline analytics development. The data pipeline layer 215 can access the data stored in the databases of the data insight layer 220 to perform analytics, as detailed above.

The application services layer 225 includes one or more components for rules engines, workflow/notifications, KPI framework, BI, machine learning, and/or an API for application services. The application services layer 225 enables building of applications 146a-d. The applications layer 230 includes one or more applications 146a-d of the IoT platform 125. For example, the applications 146a-d can include a buildings application 146a, a plants application 146b, an aero application 146c, and other enterprise applications 146d. The applications 146 can include general applications 146 for portfolio management, asset management, autonomous control, and/or any other custom applications. Portfolio management can include the KPI framework and a flexible user interface (UI) builder. Asset management can include asset performance and asset health. Autonomous control can include energy optimization and predictive maintenance. As detailed above, the general applications 146 can be extensible such that each application 146 can be configurable for the different types of enterprises 160a-160n (e.g., buildings application 146a, plants application 146b, aero application 146c, and other enterprise applications 146d).

The applications layer 230 also enables visualization of performance of the enterprise 160a-160n. For example, dashboards provide a high-level overview with drill-downs to support deeper investigations. Recommendation summaries give users prioritized actions to address current or potential issues and opportunities. Data analysis tools support ad hoc data exploration to assist in troubleshooting and process improvement.

The core services layer 235 includes one or more services of the IoT platform 125. The core services layer 235 can include data visualization, data analytics tools, security, scaling, and monitoring. The core services layer 235 can also include services for tenant provisioning, single login/common portal, self-service admin, UI library/UI tiles, identity/access/entitlements, logging/monitoring, usage metering, API gateway/dev portal, and the IoT platform 125 streams.

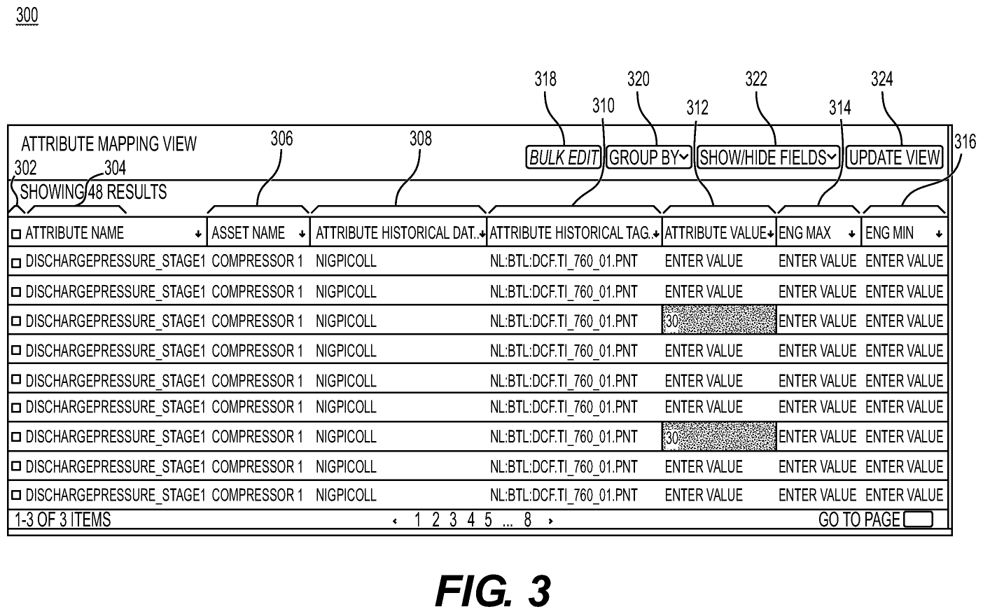

With reference to FIGS. 3-10, features for modifying EOM 250 and/or knowledge graphs 251 will be hereinafter described in detail. The features described herein relate generally to modifying EOM 250 and/or knowledge graphs 251 via a graphical user interface so that a user may easily and efficiently update IoT platform 125 to accurately and appropriately incorporate assets and/or corresponding telemetry data into the modeling. The graphical user interface may be accessed via a user device such as, for example, a desktop computer, a mobile device, etc. In some embodiments, the user device may be a cellphone, a tablet, an artificial reality AR device such as a headset, or the like. In some embodiments, the user device may include one or more end user application(s), e.g., a program, plugin, browser, browser extension, etc., installed on a memory of the user device. The end user application(s) may be associated with the IoT platform 125 and may allow a user of the user device to access features and/or information provided by IoT platform 125. In some embodiments, the end user application may be a browser and IoT platform 125 may be made available to the user via a web-based application.

FIG. 3 illustrates an exemplary tabular window 300 representing a portion of an object model in a graphical user interface. Tabular window 300 may be displayed, for example, in response to a selection or series of selections made by a user when accessing IoT platform 125. As shown in FIG. 3, exemplary tabular window 300 may be titled “ATTRIBUTE MAPPING VIEW.” Tabular window 300 may allow a user to map attributes or create associations to attributes with EOM 250. While tabular window 300 may be useful for attribute mapping, it should be understood that a tabular window according to the present disclosure need not necessarily be limited to attribute mapping and instead could be configured to allow various other modifications to EOM 250 and/or knowledge graphs 251.

Tabular window 300 may include a plurality of rows where each of the rows may correspond to an attribute. Column 302 may include a selection box for each of the rows. The selection boxes within column 302 may be individually selected or selected in groups by a user to indicate selection of one or more corresponding attributes. Column 304 may include an attribute name for each of the attributes. As shown in FIG. 3, each of the attributes listed in column 304 may be named “DISCHARGEPRESSURE_STAGE1.” It should be understood, however, that each of the attributes listed in column 304 need not share the same name and indeed may be named differently.

Column 306 may include asset names where each of the asset names corresponds to an asset with which the attribute is associated. For example, as shown in FIG. 3, each of the attributes listed in column 304 may be associated with an asset named “COMPRESSOR 1.” It should be understood, however, that each of the assets listed in column 306 need not be the same name and indeed may be different from each other.

Column 308 may include attribute historical data for each attribute listed in column 304. In some embodiments, column 308 may depict numerical or alphanumerical data for each attribute. In some embodiments, column 308 may include addresses or hyperlinks to a database including attribute historical data for each attribute. Column 310 may include an attribute historical tag for each attribute listed in column 304. Column 312 may include an attribute value for each listed attribute. In some embodiments, the attribute value for the corresponding attribute may be defined by manually entering a value into column 312. As shown, a numerical or alphanumerical value may be entered into column 312 to set a static value for a particular attribute.

Columns 314 and 316 may include a maximum and minimum value, respectively, for each of the attributes. By entering values in columns 314 and 316, a user may indicate a permissible range within which an attribute value may lie.

A user accessing tabular window 300 may make various modifications to EOM 250 and/or knowledge graphs 251 via tabular window 300. For example, for any of the attributes listed in column 304, the user may change the asset with which it is associated in column 306. The user may wish to do so in the even that an attribute is improperly mapped to an incorrect asset or not yet mapped to any asset. Likewise, for any of the attributes of column 302, the user may change any of the attribute historical data in column 308, the attribute historical tags of column 310, the attribute values of column 312, or the maximum and/or minimum values of columns 314 and 316. Any modifications made by the user within tabular window 300 may be used to update EOM 250 and/or knowledge graphs 251.

Tabular window 300 may include various additional features. For example, tabular window 300 may include an icon 318 to allow bulk editing. For example, the user may select a plurality of selection boxes in column 302 and subsequently select icon 318 to perform a bulk edit. Tabular window 300 may be configured such that upon selection of icon 318, the user may be permitted to edit multiple selected attributes at once. For example, if the user wishes to associate each of the attributes with “COMPRESSOR 2” instead of “COMPRESSOR 1,” the user may make that change without the need for changing the asset name in column 306 for each individual row.

Tabular window 300 may further include icons 320, 322, and 324. Selection of icon 320 may allow the user to group or otherwise sort items listed in tabular window 300. Icon 322 may allow the user to select additional columns to show or select columns to hide from view. Icon 324 may allow the user to refresh tabular window 300 following modifications.

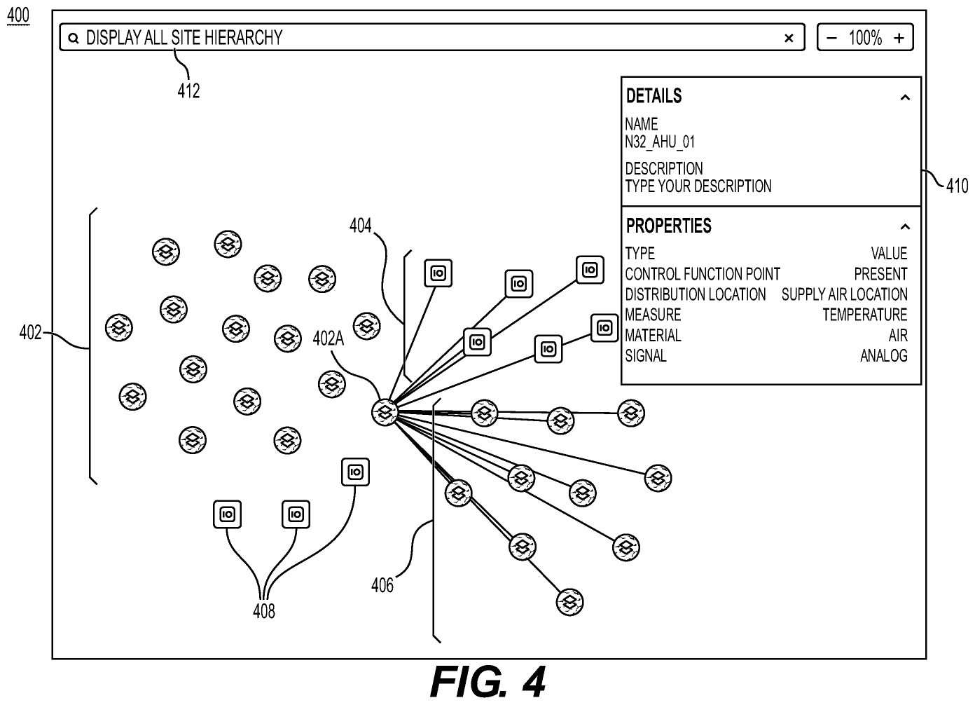

In addition to tabular views, a graphical user interface of IoT platform 125 may further provide visual representations of EOM 250 and/or knowledge graphs 251. FIG. 4 depicts an exemplary visual representation window 400. As shown in FIG. 4, visual representation window 400 may include a visual representation of a portion of EOM 250 and/or knowledge graphs 251. Specifically, exemplary visual representation window 400 may depict an object model corresponding to a particular facility or enterprise.

Visual representation window 400 may include a toolbar 412. Toolbar 412 may allow the user to define a scope of a visual representation. For example, the user may use toolbar 412 to define a visual representation to correspond to a site, a facility or enterprise, a sub-section of a facility or enterprise, a geographic region, or any other logical portion of EOM 250 and/or knowledge graphs 251. Toolbar 412 may provide a drop-down selection menu, free-text entry, or any other suitable means of parameter entry.

Visual representation window 400 may further include a plurality of location icons 402. Location icons 402 may represent subsections of a facility or enterprise, such as floors, wings, geographic regions, or the like. Location icons 402 may be expandable upon selection and/or toggling by a user. For example, location icon 402A may be shown in an expanded state. When location icon 402A is expanded, it may be depicted as associated with asset icons 404 and/or sub-location icons 406. Asset icons 404 may represent assets in the location represented by location icon 402A. For example, if location icon 402A represents the fifth floor of a facility, asset icons 404 may each represent assets located on the fifth floor of the facility. Asset icons 404 may be depicted as associated with location icon 402A via connecting lines, as shown in FIG. 4, or via any other suitable visual feature. Visual features depicting associations between elements represented in a visual representation may be referred to herein as contextual identifiers.

Sub-location icons 406 may represent more granular divisions of the location represented by location icon 402A. For example, if location icon 402A represents the fifth floor of a facility and the fifth floor includes a plurality of rooms, each of sub-location icons 406 may represent one or more rooms on the fifth floor of the facility. Alternatively, each of sub-location icons 406 may represent groups of asset systems or any other division of the location represented by location icon 402A. Like location icon 402A, sub-location icons 406 may be expandable to reveal asset icons for assets associated with a sub-location or to reveal still further sub-location icons. In some embodiments, the expansion of location icon 402A (and other icons depicted) may be toggled or togglable, such that upon instruction from the user, asset icons 404 and/or sub-location icons 406 may be selectively hidden.

Visual representation window 400 may further include unmapped asset icons 408. Unmapped asset icons 408 may each represent an asset that has not yet been associated within EOM 250 and/or knowledge graphs 251 with other elements such as locations and/or facilities. For example, unmapped asset icons 408 may not be nested within any of the location icons 402 and may not be connected by lines or any other contextual identifiers to any other icons.

Upon recognizing that unmapped asset icons 408 have not been associated with a location and/or facility, a user may wish to investigate and/or associate unmapped asset icons 408 with other elements within EOM 250 and/or knowledge graphs 251. The user may select one of the unmapped asset icons 408 and open a window 410 displaying details and properties of the unmapped asset represented by the selected unmapped asset icon 408. As shown in FIG. 4, window 410 may show that the name of a selected unmapped asset is “N32_AHU_01.” The name may be indicative, for example, of an N32 series Air Handling Unit.

In some circumstances, the user may be aware that an N32 series Air Handling Unit was recently installed on a particular floor of the depicted facility and connected to IoT platform 125. The user may accordingly wish to create associations between the N32 series Air Handling Unit and the facility, the floor of the facility in which it is located, and/or other elements of EOM 250 and/or knowledge graphs 251. The user may create such associations by navigating to a tabular window such as the tabular window depicted in FIG. 3 and modifying metadata corresponding to the N32 series Air Handling Unit. Via the tabular window, the user may associate N32 series Air Handling Unit with any of the locations represented by location icons 402, for example. Upon navigation from the tabular window back to exemplary visual representation window 400, the unmapped asset icon 408 representing the N32 series Air Handling Unit may be displayed as nested within the selected location icon 402.

It should be noted that EOM 250 and/or knowledge graphs 251 define the schema by which elements of IoT platform 125 may be associated with each other. For example, an asset may be associated with a floor of a facility by virtue of its position on the floor of the facility. Similarly, an asset may be associated with another asset by virtue of the assets being related components of the same system. EOM 250 and/or knowledge graphs 251 may, however, prohibit an element of IoT platform 125 from being associated with another element in a nonsensical fashion. For example, EOM 250 and/or knowledge graphs 251 may prohibit an association between a location and an asset that suggests that the location is positioned within the asset.

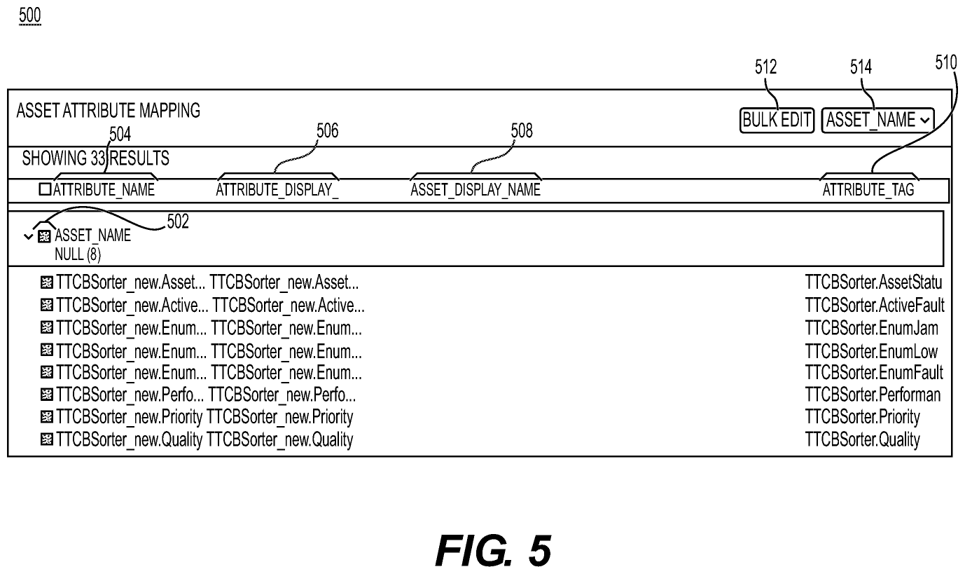

FIGS. 5-8 depict windows of a graphical user interface of IoT platform 125 that may be used for bulk editing of elements of EOM 250 and/or knowledge graphs 251 and subsequently validating the modifications. Specifically, FIGS. 5-8 illustrate a process for mapping various sensors for a tilt-tray cross-belt sorter (TTCB sorter) to the TTCB sorter within EOM 250 and/or knowledge graphs 251. A user may wish to map sensors to an asset such as a TTCB sorter when the asset and corresponding sensors are newly added to a facility or enterprise, for example.

FIG. 5 depicts another exemplary tabular window 500 that represents a portion of EOM 250 and/or knowledge graphs 251 in a graphical user interface. Tabular window 500 may be displayed, for example, in response to a selection or series of selections made by a user when accessing IoT platform 125. Tabular window 500 may be titled “ASSET ATTRIBUTE MAPPING” and may allow a user to map attributes or associate attributes with other elements of EOM 250 and/or knowledge graphs 251.

Tabular window 500 may include a plurality of rows where each of the rows may correspond to an attribute that has yet to be mapped to an asset. Column 502 may include a selection box for each of the rows. The selection boxes within column 502 may be individually selected or selected in groups by a user to indicate selection of one or more corresponding attributes. Column 504 may include an attribute name for each of the attributes. As shown in FIG. 5, column 504 may include a variety of attribute names. In some embodiments, each of the attribute names in column 504 may be indicative of the sensor and/or sensor data it represents. In some embodiments, the attribute names in column 504 may be arbitrary.

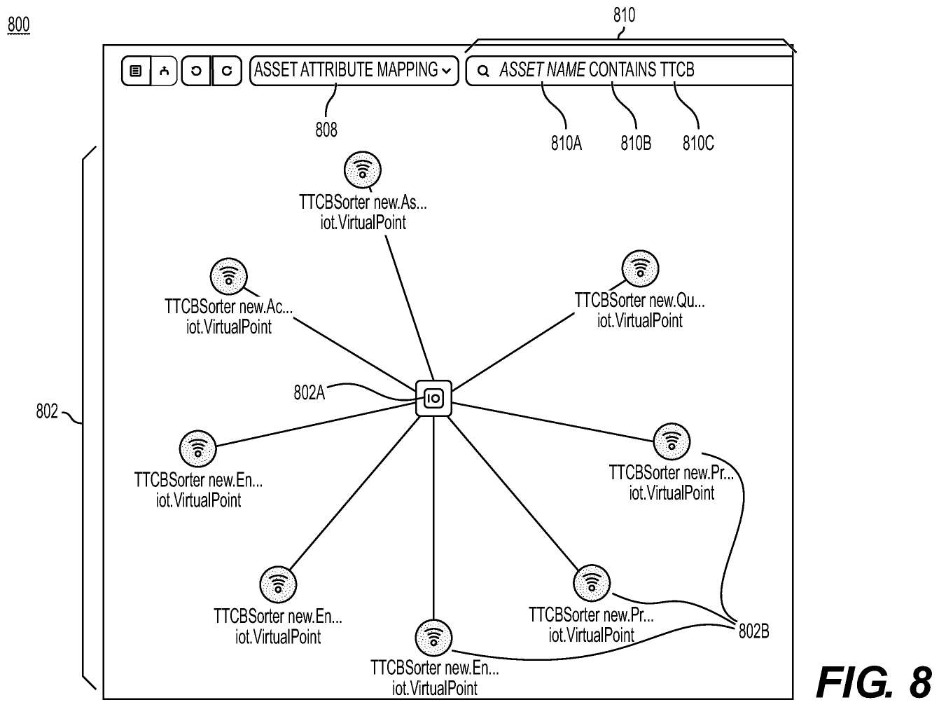

Column 506 may include an attribute display for each of the attributes. The attribute displays may correspond to alphanumeric text that is displayed in a visual representation, as shown in FIG. 8 and described hereinafter. In some embodiments, the attribute displays in column 506 may match the corresponding attribute names in column 504 by default. In some embodiments, the user may change the attribute displays as desired.

Column 508 may include an asset name for each of the attributes. An asset name in column 508 may indicate an asset with which the respective attribute is associated. As shown in FIG. 5, the fields in column 508 corresponding to each attribute may be empty, indicating that the attributes have not yet been associated with an asset.

Column 510 may include may include an attribute tag for each of the listed attributes. The attribute tags may be used for filtering as described herein previously. The attribute tags may be any appropriate value or conform to any appropriate schema for tagging and/or filtering. Tabular window 500 may further include icon 512 and 514. Icon 512 may initiate a bulk edit process and icon 514 may indicate a manner of grouping or sorting the listed items. In the example of FIG. 5, the listed attributes may be grouped by asset name, which in this case is “null” for each of the listed attributes.

A user accessing tabular window 500 may modify EOM 250 and/or knowledge graphs 251 to associate the attributes listed in column 504 with assets to which they correspond. In the example shown in FIG. 5, each of the attributes listed in column 504 may correspond to sensors configured to obtain data measurements for a TTCB sorter. To associate each of the attributes with the appropriate TTCB sorter, the user may select the corresponding selection boxes in column 502 for the desired attributes. The user may then select icon 512 indicating that a bulk edit is to be performed.

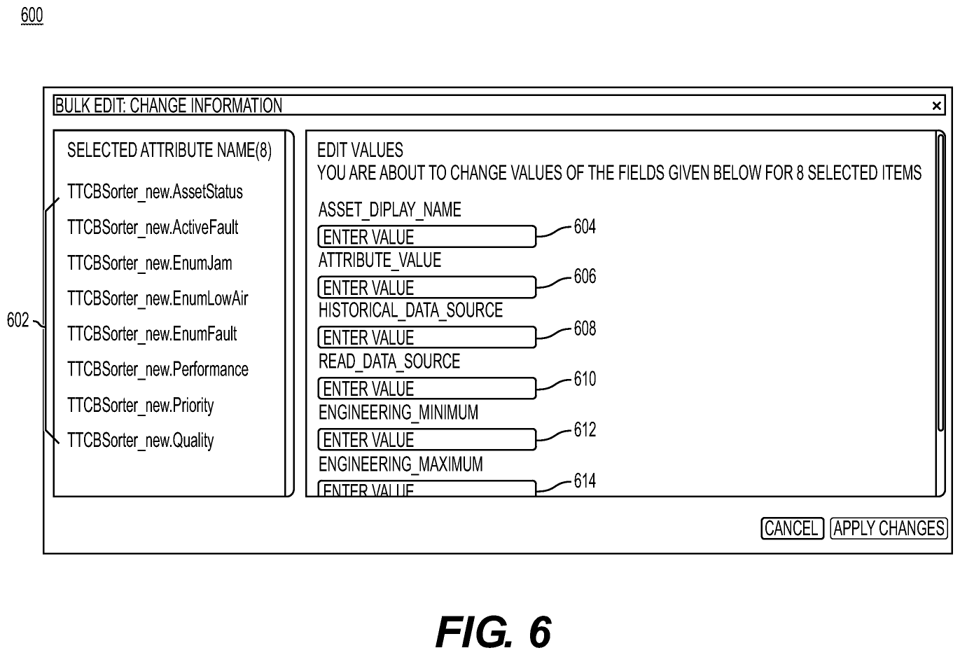

Upon selection of icon 512, the user may be redirected to the context generation menu 600 shown in FIG. 6. Context generation menu 600 may include a list 602 of the selected attribute names. List 602 may indicate the attributes from tabular window 500 selected for bulk editing. Context generation menu 600 may also include a plurality of data entry fields into which metadata for the selected attributes indicated in list 602 may be entered. For example, context generation menu 600 may include field 604 for entering an asset display name, field 606 for entering an attribute value, field 608 for entering a historical data source, field 610 for entering a read data source, field 612 for entering an engineering minimum, and field 614 for entering an engineering maximum. Context generation menu 600 may further include other fields not shown in FIG. 6. Fields 604-614 may provide drop-down menus for selecting values, may permit free-text entry, or may incorporate any other means for entering values.

Context generation menu 600 may allow the user to perform bulk editing of metadata for the attributes indicated in list 602. For example, if the user wishes to associate each of the attributes indicated in list 602 with a particular TTCB sorter, the user may enter a value indicative of the TTCB sorter in field 604. Upon selection of the “APPLY CHANGES” icon, each of the attributes indicated in list 602 may then be associated with the corresponding TTCB sorter within EOM 250 and/or knowledge graphs 251.

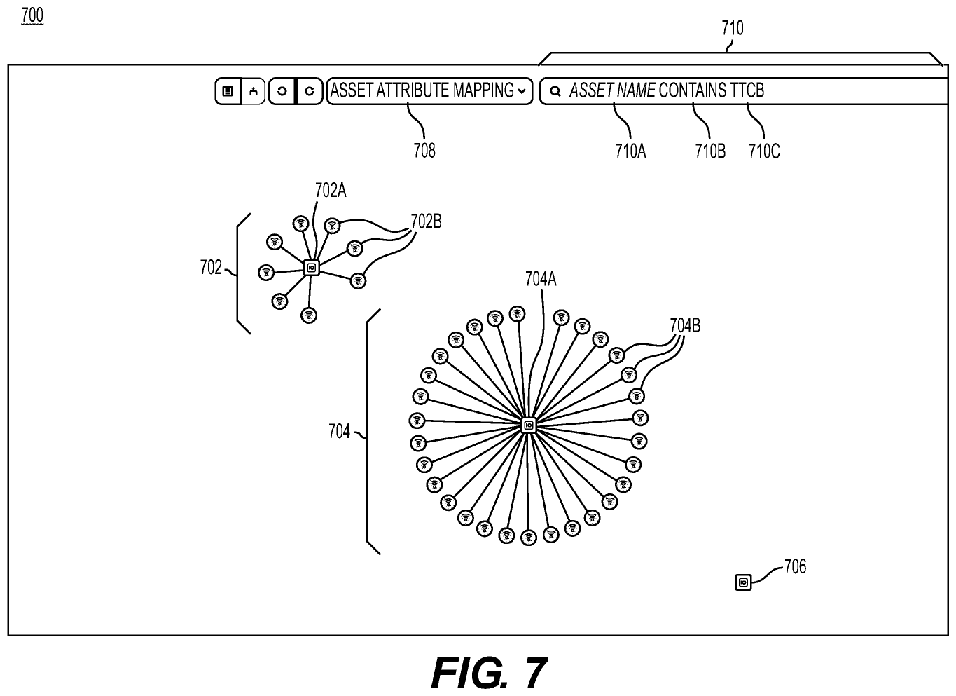

Once the user has associated each of the attributes with the asset, the user may wish to validate the changes to EOM 250 and/or knowledge graphs 251 using a visual representation. The user may accordingly navigate to such a visual representation 700, as shown in FIG. 7.

Visual representation 700 may include a definition field 708. Definition field 708 may define the scope of the visual representation. As shown in FIG. 7, definition field 708 may indicate “ASSET ATTRIBUTE MAPPING,” which may in turn cause visual representation 700 to depict associations between assets and attributes. In some embodiments, definition field 708 may indicate other types of mapping, including mapping among facilities, locations, sub-locations, assets, attributes, and/or other elements of EOM 250 and/or knowledge graphs 251.

Visual representation 700 may also include filter field 710. Filter field 710 may permit a user to filter elements shown in visual representation 700 to a subset of elements in EOM 250 and/or knowledge graphs 251. For example, filter field 710 may allow a user to specify an element type 710A, a match type 710B, and a text match 710C. As shown in FIG. 7, the user may specify element type 710A as “ASSET NAME,” match type 710B as “CONTAINS,” and text match 710C as “TTCB.” The query shown entered into filter field 710 in FIG. 7 may therefore cause assets having names that include “TTCB” and any attributes associated with those assets to be depicted in visual representation 700.

Visual representation 700 may include an asset cluster 702 and an asset cluster 704. Asset cluster 702 may include a mapped asset icon 702A and a plurality of mapped attribute icons 702B (also referred to herein as telemetry icons). Mapped asset icon 702A may be representative of a first TTCB sorter, due to the query entered into filter field. Mapped attribute icons 702B may be representative of telemetry data measured by sensors for, and associated with, the first TTCB sorter. For example, each of the mapped attribute icons 702B may be representative of a distinct sensor and the data the sensor generates. Mapped attribute icons 702B may be visually linked to mapped asset icon 702A via connecting lines or other graphical indicators (also referred to herein as contextual identifiers).

Asset cluster 704 may similarly include a mapped asset icon 704A and a plurality of mapped attribute icons. Mapped asset icon 704A may be representative of a second TTCB sorter. Mapped attribute icons 704B may be representative of telemetry data measured by sensors for the second TTCB sorter. For example, each of the mapped attribute icons 704B may be representative of a distinct sensor and the data the sensor generates. Mapped attribute icons 704B may be visually linked to mapped asset icon 704A via connecting lines or other contextual identifiers.

Visual representation 700 may further include an unmapped asset icon 706. Unmapped asset icon 706 may be representative of a third TTCB sorter that has not yet been mapped to any attributes. Accordingly, unmapped asset icon 706 may be shown without any corresponding mapped attribute icons.

To validate the changes to EOM 250 and/or knowledge graphs 251 as described previously with reference to FIGS. 5 and 6, the user may wish to zoom in further on asset cluster 702. The user may wish to zoom in on cluster 702 because, for example, the user believes that he or she associated the attributes indicated in list 602 with the first TTCB sorter represented by mapped asset icon 702A. The user may instruct the system accordingly, by entering a selection or series of selections, in response to which the system may cause visual representation 800 to be displayed.

Visual representation 800 may include essentially the same elements as visual representation 700, but with asset cluster 704 and unmapped asset icon 706 removed. Specifically, visual representation 800 may include a definition field 808 which may define the scope of the visual representation. Visual representation 800 may also include filter field 810, which may be substantially similar to filter field 710. Filter field 810 may allow the user to specify an element type 810A, a match type 810B, and a text match 810C.

Visual representation 800 may include an asset cluster 802. Asset cluster 802 may include a mapped asset icon 802A, which may be the same as mapped asset icon 702A, and a plurality of mapped attribute icons 802B, which may be the same as mapped attribute icons 702B. Mapped attribute icons 802B may include text indicative of the corresponding attribute names. As shown in FIG. 8, the text with each of mapped attribute icons 802B may correspond to the attribute names included in list 602, described herein previously. The user may thereby confirm that the changes described previously with reference to FIGS. 5 and 6 have been incorporated into EOM 250 and/or knowledge graphs 251 by verifying that each of mapped attribute icons 802B is connected to mapped asset icon 802A, as expected. The user may then proceed to make additional changes to EOM 250 and/or knowledge graphs 251 as needed.

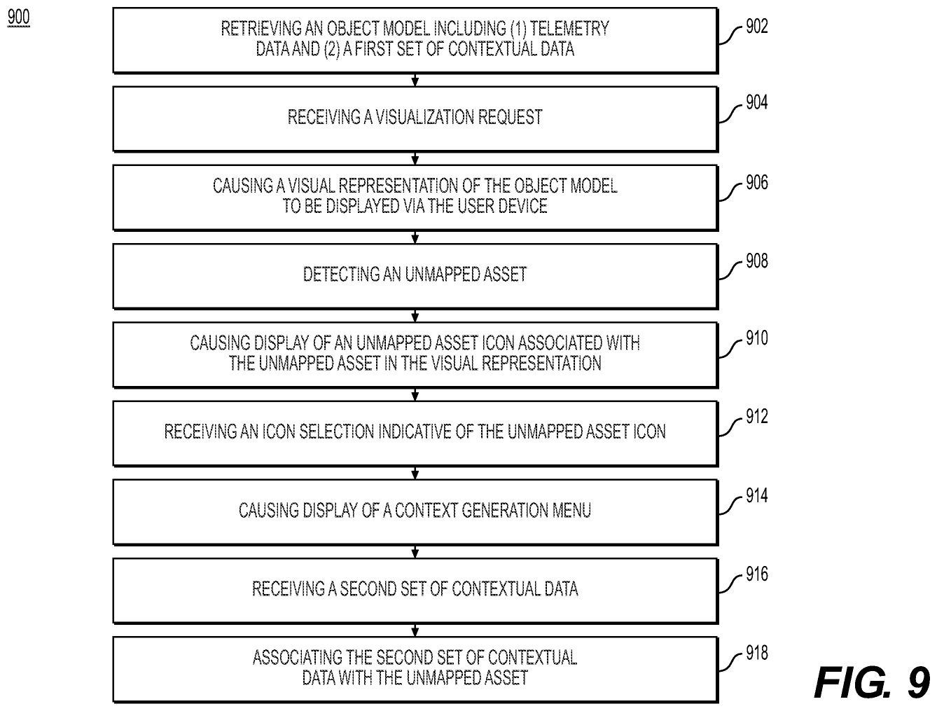

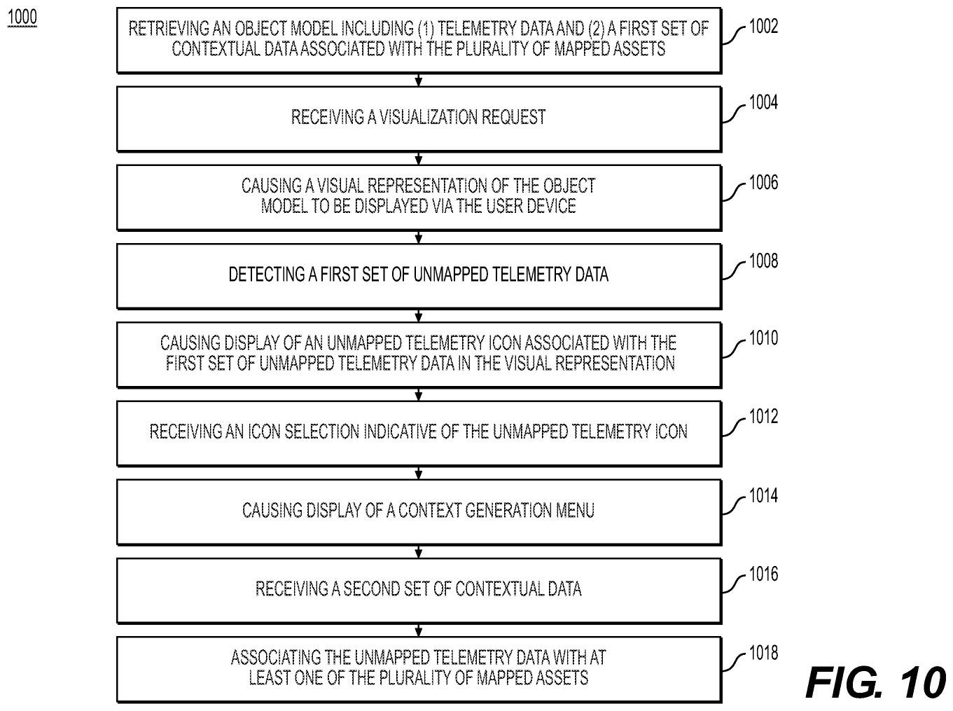

Hereinafter, methods of modifying object models of the systems previously disclosed are described. It should be understood that in various embodiments, various components or combinations of components of the systems discussed previously may execute instructions or perform acts including the acts discussed below. Further, it should be understood that in various embodiments, various steps may be added, omitted, and/or rearranged in any suitable manner. For brevity, the term “system” will be used in the description of FIGS. 9 and 10 provided hereinafter, though it should be understood that the term “system” may encompass any one or more of the computer systems described herein.

FIG. 9 depicts an exemplary method 900 of modifying an object model via a graphical user interface, according to one or more embodiments. It should be understood that the method 900 may include fewer than all steps shown in FIG. 9 or may alternatively include additional steps not shown in FIG. 9.

At step 902, the system may retrieve an object model. The object model may be EOM 250 and may include knowledge graphs 251. The object model may therefore include telemetry data associated with a plurality of mapped assets. The mapped assets may be any type of assets incorporated into IoT platform 125. The telemetry data may include data generated by sensors for the purpose of measuring various metrics of the mapped assets. The object model may further include a first set of contextual data associated with the plurality of mapped assets. The first set of contextual data may define various relationships between the plurality of mapped assets and other elements of EOM 250 and/or knowledge graphs 251, including, but not limited to, facilities, locations, sub-locations, system groupings, telemetry data, and the like.

At step 904, the system may receive a visualization request from a user device. The user device may be any device used to access IoT platform 125. The visualization request may indicate that a user of the user device desires for a visual representation of EOM 250 and/or knowledge graphs 251 to be displayed. The visualization request may be, for example, an icon selection, a combination of icon selections, a keystroke or combination of keystrokes, etc.

At step 906, in response to receiving the visualization request, the system may cause a visual representation of EOM 250 and/or knowledge graphs 251 to be displayed via the user device. The visual representation may appear similarly to those described herein previously with reference to FIGS. 4, 7 and 8. The visual representation may include a plurality of asset icons and a first set of contextual identifiers. Each of the plurality of asset icons may be associated with at least one of the plurality of mapped assets. The first set of contextual identifiers may be indicative of the first set of contextual data and may include, for example, graphical features such as connecting lines demonstrating relationships between the mapped assets and other elements represented in the visual representation.

At step 908, the system may detect an unmapped asset. The unmapped asset may be an asset for which relationships to other elements have yet to be defined in EOM 250 and/or knowledge graphs 251. For example, when an asset is newly added to a facility or enterprise and is connected to IoT platform 125 for the first time, relationships between that asset and other elements may not be defined.

At step 910, the system may cause an unmapped asset icon to be displayed in the visual representation. The unmapped asset icon may be representative of the unmapped asset detected in step 908. The unmapped asset may, for example, appear similarly as unmapped asset icon 706 appears in visual representation 700.

At step 912, the system may receive an icon selection indicative of the unmapped asset icon from the user device. At step 914, in response to the icon selection, the system may cause display of a context generation menu. The context generation menu may allow the user to enter and/or modify metadata associated with the unmapped asset within EOM 250 and/or knowledge graphs 251.

At step 916, the system may receive a second set of contextual data from the user device. The second set of contextual data may correspond to data entered or selected by the user via the context generation menu. For example, the user may specify via the context generation menu a facility in which the asset is located, a floor on which the asset is located, a room in which the asset is located, a system of which the asset is a part, any other metadata that may be relevant to the unmapped asset, and/or may define relationships between the unmapped asset and other elements of EOM 250 and/or knowledge graphs 251.

At step 918, in response to receiving the second set of contextual data, the system may associate the second set of contextual data with the unmapped asset. By associating the second set of contextual data with the unmapped asset, the system may commit any metadata entered by the user for the unmapped asset and/or relationships between the unmapped asset and other elements to EOM 250 and/or knowledge graphs 251.

In some embodiments, the system may then update the visual representation to include a second set of contextual identifiers that are indicative of the second set of contextual data. For example, the visual representation may be updated to include lines connecting the unmapped asset to other elements of EOM 250 and/or knowledge graphs 251 for which relationships have been defined.

While method 900 is described herein with reference to an unmapped asset and an unmapped asset icon, it should be understood that the system may be capable of detecting multiple unmapped assets and displaying multiple unmapped asset icons. Moreover, the system may be used to modify EOM 250 and/or knowledge graphs 251 with respect to multiple unmapped assets in a bulk modification process, as described herein previously.

It is to be understood that method 900 need not necessarily be performed in the exact order described herein and the steps described herein may be rearranged in some embodiments. Further, in some embodiments fewer than all steps of method 900 may be performed and in some embodiments additional steps may be performed.

Method 900 as described herein may allow a user to modify EOM 250 and/or knowledge graphs 251 via a graphical user interface to define relationships between elements of EOM 250 and knowledge graphs 251. When a new asset is added to IoT platform 125, a user need not wait for a system administrator to code the various relationships between the asset and other elements into EOM 250 and/or knowledge graphs 251. Rather, the user may update EOM 250 and/or knowledge graphs 251 in an easy and intuitive way, thereby allowing the user to utilize other beneficial features of IoT platform 125 with the new asset.

FIG. 10 depicts an exemplary method 1000 of modifying an object model via a graphical user interface, according to one or more embodiments. It should be understood that the method 1000 may include fewer than all steps shown in FIG. 10 or may alternatively include additional steps not shown in FIG. 10.

At step 1002, the system may retrieve an object model. The object model may be EOM 250 and may include knowledge graphs 251. The object model may therefore include telemetry data associated with a plurality of mapped assets. The mapped assets may be any type of assets incorporated into IoT platform 125. The telemetry data may include data generated by sensors for the purpose of measuring various metrics of the mapped assets. The object model may further include a first set of contextual data associated with the plurality of mapped assets. The first set of contextual data may define various relationships between the plurality of mapped assets and the telemetry data.

At step 1004, the system may receive a visualization request from a user device. The user device may be any device used to access IoT platform 125. The visualization request may indicate that a user of the user device desires for a visual representation of EOM 250 and/or knowledge graphs 251 to be displayed. The visualization request may be, for example, an icon selection or a combination of icon selections, a keystroke or combination of keystrokes, etc.

At step 1006, in response to receiving the visualization request, the system may cause a visual representation of EOM 250 and/or knowledge graphs 251 to be displayed via the user device. The visual representation may appear generally as described herein previously with reference to FIGS. 4, 7 and 8. The visual representation may include a plurality of telemetry icons, a plurality of asset icons, and a first set of contextual identifiers. Each of the plurality of telemetry icons may be associated with telemetry data for at least one of the plurality of mapped assets. Each of the plurality of asset icons may be associated with at least one of the plurality of mapped assets. The first set of contextual identifiers may be indicative of the first set of contextual data and may include, for example, graphical features such as lines demonstrating relationships between the mapped assets and items of telemetry data.

At step 1008, the system may detect a first set of unmapped telemetry data. The first set of unmapped telemetry data may be telemetry data for which relationships to other elements, such as assets, have yet to be defined in EOM 250 and/or knowledge graphs 251. For example, when a sensor is newly added to a facility or enterprise and is connected to IoT platform 125 for the first time, relationships between the telemetry data generated by that sensor and other elements may not be defined.

At step 1010, the system may cause an unmapped telemetry icon to be displayed in the visual representation. The unmapped telemetry icon may be representative of the first set of unmapped telemetry data detected in step 1008.

At step 1012, the system may receive an icon selection indicative of the unmapped telemetry icon from the user device. At step 1014, in response to the icon selection, the system may cause display of a context generation menu. The context generation menu may allow the user to enter and/or modify metadata associated with the unmapped telemetry data within EOM 250 and/or knowledge graphs 251.

At step 1016 the system may receive a second set of contextual data from the user device. The second set of contextual data may correspond to data entered or selected by the user via the context generation menu. For example, the user may specify via the context generation menu an asset or assets with which the telemetry data is associated, may provide other metadata that may be relevant to the unmapped telemetry data, and/or may define relationships between the unmapped telemetry data and other elements of EOM 250 and/or knowledge graphs 251.

At step 1018, in response to receiving the second set of contextual data, the system may associate the unmapped telemetry data with at least one of the plurality of assets. By associating the unmapped telemetry data with at least one of the plurality of assets, the system may commit the relationship between the unmapped telemetry data and the at least one mapped asset to EOM 250 and/or knowledge graphs 251.

In some embodiments, the system may then update the visual representation to include a second set of contextual identifiers that are indicative of the association between the unmapped telemetry data and the at least one mapped asset. For example, the visual representation may be updated to include lines connecting the unmapped telemetry icon to a mapped asset icon.

While method 1000 is described herein with reference to a first set of unmapped telemetry data and an unmapped telemetry icon, it should be understood that the system may be capable of detecting multiple sets of unmapped telemetry data and displaying multiple unmapped telemetry icons. Moreover, the system may be used to modify EOM 250 and/or knowledge graphs 251 with respect to multiple sets of unmapped telemetry data in a bulk modification process, as described herein previously.

It is to be understood that method 1000 need not necessarily be performed in the exact order described herein and the steps described herein may be rearranged in some embodiments. Further, in some embodiments fewer than all steps of method 900 may be performed and in some embodiments additional steps may be performed.

Method 1000 as described herein may allow a user to modify EOM 250 and/or knowledge graphs 251 via a graphical user interface to define relationships between elements of EOM 250 and knowledge graphs 251. Specifically, when new telemetry data is incorporated into IoT platform 125, a user need not wait for a system administrator to code the various relationships between the telemetry data and assets into EOM 250 and/or knowledge graphs 251. Rather, the user may update EOM 250 and/or knowledge graphs 251 in an easy and intuitive way, thereby allowing the user to more quickly utilize other beneficial features of IoT platform 125 with the new telemetry data.

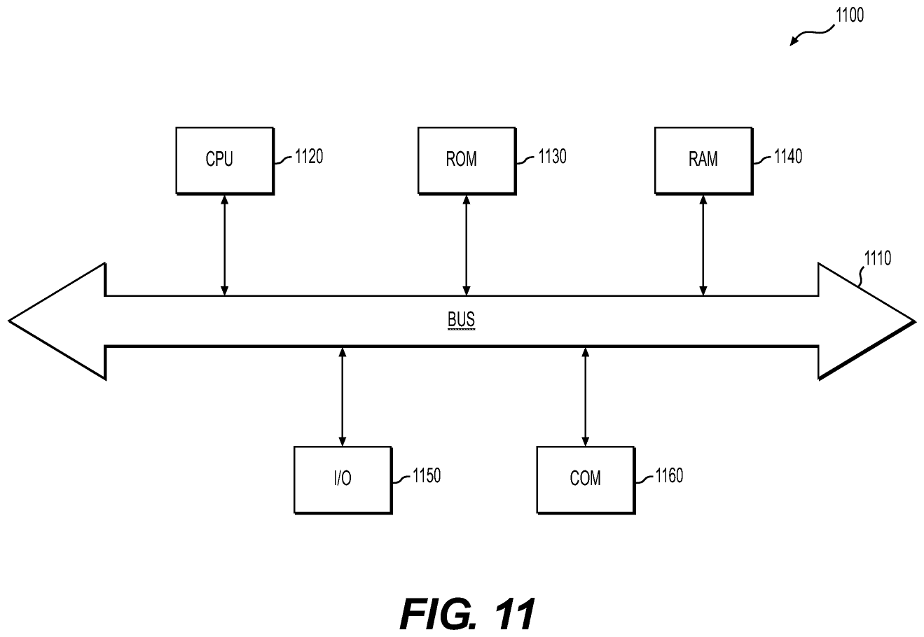

FIG. 11 depicts an example system that may execute techniques presented herein. FIG. 11 is a simplified functional block diagram of a computer that may be configured to execute techniques described herein, according to exemplary embodiments of the present disclosure. Specifically, the computer (or “platform” as it may not be a single physical computer infrastructure) may include a data communication interface 1160 for packet data communication. The platform may also include a central processing unit (“CPU”) 1120, in the form of one or more processors, for executing program instructions. The platform may include an internal communication bus 1110, and the platform may also include a program storage and/or a data storage for various data files to be processed and/or communicated by the platform such as ROM 1130 and RAM 1140, although the system 1100 may receive programming and data via network communications. The system 1100 also may include input and output ports 1150 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In one embodiment, any of the disclosed systems and/or methods may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the internet or various other telecommunication networks. Such communications, for example, may enable loading of the software from one computer or processor into another, for example, from a management server or host computer of a mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, “one or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first selection could be termed a second selection, and, similarly, a second selection could be termed a first selection, without departing from the scope of the various described embodiments. The first selection and the second selection are both selections, but they are not the same selection.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

In this disclosure, relative terms, such as, for example, “about,” “substantially,” “generally,” and “approximately” are used to indicate a possible variation of ±10% in a stated value.

The term “exemplary” is used in the sense of “example” rather than “ideal.”

Other embodiments of the disclosure will be apparent to those skilled in the art from consideration of the specification and practice of the embodiments disclosed herein. It is intended that the specification and examples be considered as exemplary only, with a true scope and spirit of the present disclosure being indicated by the following claims.

What is claimed is:

1. A method, comprising:
retrieving, by a system comprising at least one processor, an object model including (1) telemetry data associated with a plurality of mapped assets and (2) a first set of contextual data associated with the plurality of mapped assets;
receiving, by the system from a user device, a visualization request;
causing, by the system in response to the visualization request, a visual representation of the object model to be displayed via the user device, the visual representation including (1) a plurality of asset icons, wherein each of the plurality of asset icons is associated with at least one of the plurality of mapped assets, and (2) a first set of contextual identifiers indicative of the first set of contextual data;
detecting, by the system, an unmapped asset;
causing, by the system, display of an unmapped asset icon associated with the unmapped asset in the visual representation;
receiving, by the system from the user device, an icon selection indicative of the unmapped asset icon;
causing, by the system in response to the icon selection, display of a context generation menu;
receiving, by the system from the user device via the context generation menu, a second set of contextual data; and
associating, by the system in response to receiving the second set of contextual data, the second set of contextual data with the unmapped asset.

2. The method of claim 1, further comprising:
causing, by the system in response to associating the second set of contextual data with the unmapped asset, a second set of contextual identifiers indicative of the second set of contextual data to be displayed in the visual representation.

3. The method of claim 2, wherein the second set of contextual data is indicative of a facility in which the unmapped asset is located.

4. The method of claim 3, wherein the second set of contextual data is indicative of an area of the facility in which the unmapped asset is located.

5. The method of claim 1, wherein the visual representation further includes a plurality of telemetry icons, wherein each of the plurality of telemetry icons is associated with telemetry data for at least one of the plurality of mapped assets.

6. The method of claim 1, further comprising:
receiving, by the system from the user device, a bulk icon selection indicative of a first subset of the plurality of asset icons;
receiving, by the system from the user device, a third set of contextual data; and
associating, by the system in response to receiving the third set of contextual data, the third set of contextual data with each of the first subset of the plurality of asset icons.

7. The method of claim 1, wherein the first set of contextual identifiers includes a plurality of location icons, wherein each of the plurality of asset icons is associated with at least one of the plurality of location icons.

8. The method of claim 7, wherein each of the plurality of location icons is configured to be togglable such that associated asset icons may be selectively hidden.

9. The method of claim 8, further comprising:
receiving, by the system from the user device, a location icon selection indicative of one of the plurality of location icons; and
removing, by the system in response to receiving the location icon selection, location icons not indicated by the location icon selection from the visual representation.

10. A method, comprising:
retrieving, by a system comprising at least one processor, an object model including (1) telemetry data associated with a plurality of mapped assets and (2) a first set of contextual data associated with the plurality of mapped assets;
receiving, by the system from a user device, a visualization request;
causing, by the system in response to the visualization request, a visual representation of the object model to be displayed via the user device, the visual representation including (1) a plurality of telemetry icons, wherein each of the plurality of telemetry icons is associated with telemetry data for at least one of the plurality of mapped assets, (2) a plurality of asset icons associated with at least one of the plurality of mapped assets, and (3) a first set of contextual identifiers indicative of the first set of contextual data and linking each of the plurality of telemetry icons to at least one of the plurality of asset icons;
detecting, by the system, a first set of unmapped telemetry data;
causing, by the system, display of an unmapped telemetry icon associated with the first set of unmapped telemetry data in the visual representation;
receiving, by the system from the user device, an icon selection indicative of the unmapped telemetry icon;
causing, by the system in response to the icon selection, display of a context generation menu;
receiving, by the system from the user device via the context generation menu, a second set of contextual data; and
associating, by the system in response to receiving the second set of contextual data, the unmapped telemetry data with at least one of the plurality of mapped assets based on the second set of contextual data.

11. The method of claim 10, further comprising:
causing, by the system in response to associating the second set of contextual data with the unmapped telemetry data, to be displayed in the visual representation a second set of contextual identifiers indicative of associations between the unmapped telemetry data and the at least one of the plurality of mapped assets.

12. The method of claim 11, further comprising:
detecting, by the system, a plurality of sets of unmapped telemetry data;
causing, by the system, display of a plurality of unmapped telemetry icons, wherein each of the plurality of unmapped telemetry icons is associated with at least one of the plurality of sets of unmapped telemetry data in the visual representation, wherein the icon selection is indicative of the plurality of unmapped telemetry icons; and
associating, by the system in response to receiving the second set of contextual data, each of the plurality of sets of unmapped telemetry data with at least one of the plurality of mapped assets based on the second set of contextual data.

13. The method of claim 10, wherein the first set of contextual data is indicative of a facility in which at least one of the plurality of mapped assets is located.

14. The method of claim 13, wherein the first set of contextual identifiers includes a plurality of location icons, wherein each of the plurality of asset icons is associated with at least one of the plurality of location icons.

15. The method of claim 14, wherein each of the plurality of location icons is configured to be togglable such that associated asset icons and telemetry icons may be selectively hidden.

16. The method of claim 10, further comprising:
receiving, by the system from the user device, an asset icon selection indicative of one of the plurality of asset icons; and
removing, by the system in response to receiving the asset icon selection, asset icons not indicated by the asset icon selection from the visual representation.

17. A system, comprising:
one or more memories storing instructions; and
one or more processors operatively connected to the one or more memories, the one or more processors configured to execute the instructions to:
retrieve an object model including (1) telemetry data associated with a plurality of mapped assets and (2) a first set of contextual data associated with the plurality of mapped assets;
receive, from a user device, a visualization request;
cause, in response to the visualization request, a visual representation of the object model to be displayed via the user device, the visual representation including (1) a plurality of telemetry icons, wherein each of the plurality of telemetry icons is associated with telemetry data for at least one of the plurality of mapped assets, (2) a plurality of asset icons associated with at least one of the plurality of mapped assets, and (3) a first set of contextual identifiers indicative of the first set of contextual data and linking each of the plurality of telemetry icons to at least one of the plurality of asset icons;
detect a plurality of sets of unmapped telemetry data;
cause display of a plurality of unmapped telemetry icons, wherein each of the plurality of unmapped telemetry icons is associated with one of the plurality of sets of unmapped telemetry data in the visual representation;
receive, from the user device, a bulk icon selection indicative of the plurality of unmapped telemetry icons;
cause, in response to the bulk icon selection, display of a context generation menu;
receive, from the user device via the context generation menu, a second set of contextual data; and
associate, in response to receiving the second set of contextual data, each of the plurality of sets of unmapped telemetry data with at least one of the plurality of mapped assets based on the second set of contextual data.

18. The system of claim 17, wherein the one or more processors are further configured to:
cause, in response to associating each of the plurality of sets of unmapped telemetry data with at least one of the plurality of mapped assets, to be displayed in the visual representation a second set of contextual identifiers indicative of associations between each of the plurality of sets of unmapped telemetry data with at least one of the plurality of mapped assets.

19. The system of claim 17, wherein the one or more processors are further configured to:
receive, from the user device, an asset icon selection indicative of one of the plurality of asset icons; and
remove, in response to receiving the asset icon selection, asset icons not indicated by the asset icon selection from the visual representation.

20. The system of claim 19, wherein the one or more processors are further configured to:
remove, in response to receiving the asset icon selection, unmapped telemetry icons not associated with the asset icon indicated by the asset icon selection from the visual representation.
